(19) United States
(12) Patent Application Publication
(10) Pub. No.: US 2021/0226496 A1
(43) Pub. Date: Jul. 22, 2021

(54) ELECTRIC MACHINE COOLING WITH COOLANT ORIFICE PLATES

(71) Applicant: Ford Global Technologies, LLC, Dearborn, MI (US)

(72) Inventors: Alfredo R. MUNOZ, Ann Arbor, MI (US); Michael W. DEGNER, Novi, MI (US); Myung Ki SUNG, Ypsilanti, MI (US)

(21) Appl. No.: 16/745,029

(22) Filed: Jan. 16, 2020

(51) Int. Cl. H02K 3/24; H02K 9/193

(52) U.S. Cl. CPC H02K 3/24; H02K 9/193

(57) ABSTRACT

A cooling system for an electric vehicle motor may include a stator having a plurality of coils forming end windings at each of an end of the stator and at least one orifice plate arranged at the end windings of at least one end of the stator, the orifice plate including a plurality of nozzles configured to supply coolant at the end windings.

### TECHNICAL FIELD

Disclosed herein are coolant orifice plates for electric machine cooling.

### BACKGROUND

Electric machines, including electric generators, motors, sirens, etc., may include a stator surrounding a rotor. The stator may be attached to a case and energy may flow through the stator to or from the rotor. The stator may include an iron core and copper windings. During operation, the copper windings may carry current, which in turn may generate heat.

### SUMMARY

A cooling system for an electric vehicle motor may include a stator having a plurality of coils forming end windings at each of an end of the stator; and at least one orifice plate arranged at the end windings of at least one end of the stator, the orifice plate including a plurality of nozzles configured to supply coolant at the end windings.

A cooling system for an electric vehicle motor may include a stator having a plurality of coils forming end windings at each of an end of the stator; at least one orifice plate arranged at the end windings of at least one end of the stator, the orifice plate configured to supply coolant at the end windings and a housing surrounding the stator and defining an opening at the end windings to maintain the at least one orifice plate therein.

A cooling system for an electric vehicle motor may include a housing configured to surround a stator having a plurality of coils forming end windings at each of an end of the stator, the housing configured to define at least one orifice plate arranged at the end windings of at least one end of the stator, the housing further defining a plurality of nozzles at the orifice plate to supply coolant between the end windings.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a perspective view of an example cooling system for a stator for an electric motor of a motor vehicle;

FIG. 2 illustrates a cross-sectional perspective view of the example cooling system of FIG. 1;

FIG. 3 illustrates a side view of the example cooling system arranged within a housing;

FIG. 4 illustrates a cut-away perspective view of the example system of FIG. 3 without illustrating the end windings;

FIG. 5 illustrates a side view of another example cooling system;

FIG. 6 illustrates a plurality of nozzles 170 arranged in two rows;

FIG. 7 illustrates a side view of the nozzle configuration of FIG. 6 illustrating the coolant flow;

FIG. 8 illustrates a top view of the orifice plate having another nozzle configuration;

FIG. 9 illustrates a top view of an orifice plate 140 having a least one semi-circular nozzle;

FIG. 10 illustrates a coolant flow for the nozzle configuration of FIG. 9;

FIG. 11 illustrates a top view of an orifice plate 140 having spray nozzles 188 arranged thereon;

FIG. 12 illustrates a perspective view of the spray nozzles of FIG. 11 illustrating a spray pattern onto the end windings; and

FIG. 13 illustrates a side view of another exemplary cooling system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Electric machines, including electric generators, motors, sirens, etc., may include a stator surrounding a rotor. The stator may be attached to a case and energy may flow through the stator to or from the rotor. The stator may include an iron core and copper windings. A portion of the copper windings may protrude from the iron core, known as end windings. During operation, the copper windings may carry current, which in turn may generate heat. The iron core may also generate heat. However, this heat may cause inefficiencies in the motor. In order to decrease such inefficiencies, the stator may be cooled by a cooling medium, such as transmission oil, lubricant, coolant, other liquid, etc. This cooling medium may reduce the temperature of the winding and therefore increase the winding's ability to carry current. The end windings may be cooled by the cooling medium.

Typically, electric machines are cooled by dripping automotive transmission oil (ATF) onto the end windings through orifices in a transmission housing. Spay configurations or centrifugal impingement cooling from the rotor end plates may also be used. However, such cooling schemes may lead to sparse or spotty coverage of the cooling medium over the end windings. This non-uniformity of the coolant flow may lead to localized hot spots or areas with extremely high temperatures in the end windings.

Disclosed herein is a cooling system having at least one orifice plate arranged at the end-windings to provide for more uniform coolant coverage at the end windings. The at least one orifice plate may include a pair of plates on each side of the iron core. The plates may be arranged next to or above each end winding o provide better coolant flow control. The plates may form a round circular-type or disc-like shape configured to align or cover the end windings. In some examples, the plates' diameter may be larger than that of the end windings to allow for coolant injection at the top of the end windings and to take into consideration the circumferential direction of the coolant.

The more uniform coverage will significantly reduce the maximum average operating temperatures of the end windings, which in turn can reduce the required electric machine size. The more uniform coverage may also increase electric machine torque densities.

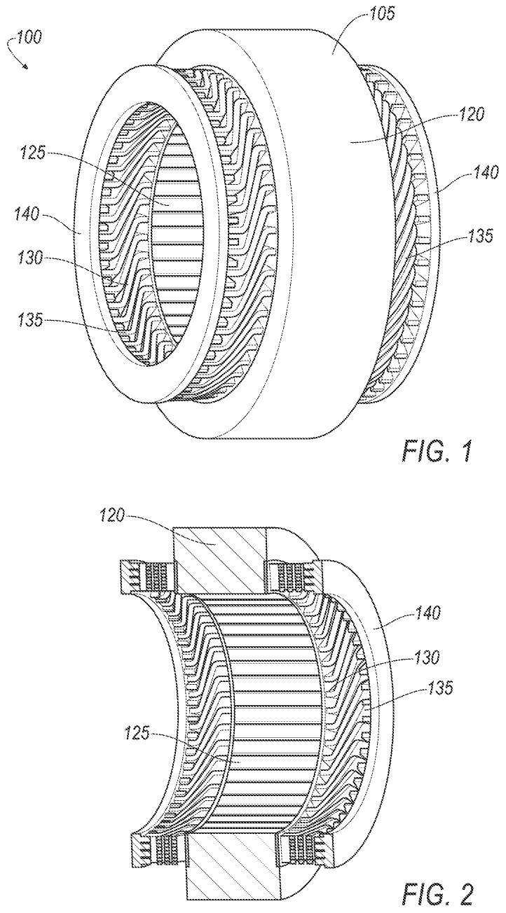

FIG. 1 illustrates a perspective view of an example cooling system 100 for a stator 105 for an electric motor of a motor vehicle. FIG. 2 illustrates a cross-sectional perspective view of the example cooling system 100 of FIG. 1. Referring to FIGS. 1 and 2, the motor vehicle may be a component of an electric vehicle (EV) including a hybrid electric vehicle (HEV) powered both by fuel and electricity, a plug-in hybrid electric vehicle (PHEV), and a battery electric vehicle (BEV). In electric vehicles, the efficiency of the motor may be very important and inefficiencies in the motor may cause a decrease in driving range.

The stator 105 may be configured to act as a magnet to allow energy to form and flow therethrough in an electric motor. The stator 105 may be made of iron, aluminum, steel, copper, etc. The stator 105 may be made of a plurality of laminations (not individually labeled) that are placed side-by-side and stacked to form the disk-like circular form of the stator 105. The laminations may form an iron core 120, or back iron, of the stator 105. The iron core 120 may be a solid portion around the outer periphery of the stator 105. Each lamination may also form teeth 125 extending radially inward from the back iron into the center of the stator 105. When aligned and stacked, the teeth 125 extend axially along a length of the stator 105. The stator teeth 125 may be configured to maintain coils 130 therebetween.

The coils 130 may include a plurality of wires and may extend outward from the axial ends of the stator 105. These end portions are referred to as end windings 135 and include the exposed portion of the coils 130. These end windings 135 may receive a cooling medium, or coolant, such as transmission oil or other liquid to dissipate or extract heat from the iron core 120.

At least one orifice plate 140 may be arranged at or next to at least one of the end windings 135. In the example shown in FIGS. 1 and 2, a pair of orifice plates 140 are included in the cooling system 100, however, one orifice plate 140 may be included. The orifice plate 140 may form a circular shape having a similar or near similar diameter to that of the end windings 135. In one example, the orifice plate 140 may have a slightly larger diameter so as to completely cover and extend past the end windings 135. The orifice plate 140 may define a hollow center opening creating a ring-like shape. The plate 140 may be part of housing as a single piece, or may be comprised of multiple pieces and inserted into the housing piece by piece.

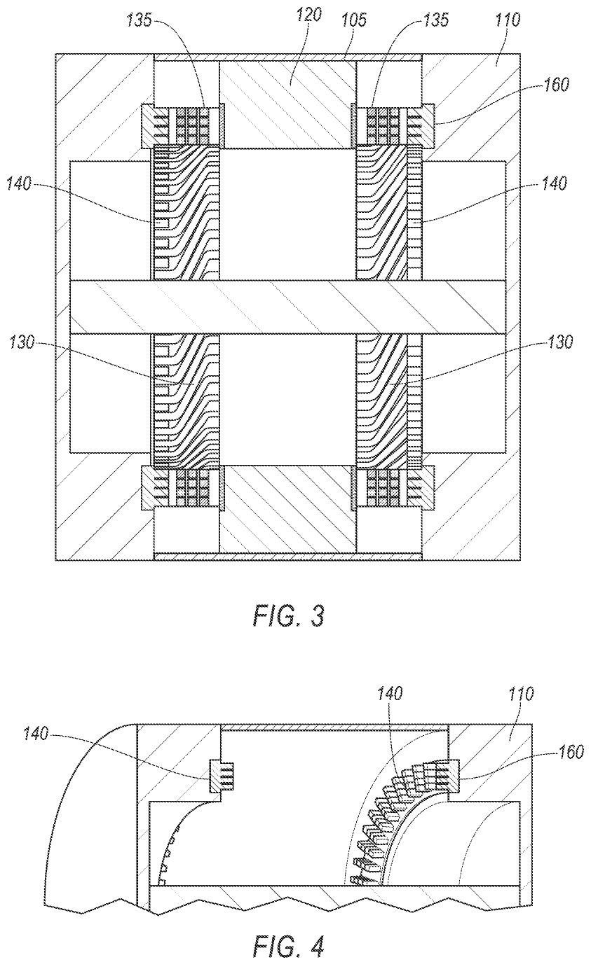

FIG. 3 illustrates a side view of the example cooling system 100 arranged within a housing 110. FIG. 4 illustrates a cut-away perspective view of the example system 100 of FIG. 3 without illustrating the stator 105, including the end windings 135. The housing 110 may be a case configured to surround and house the stator 105. The housing 110 may be affixed to the stator 105 such that the case may maintain the stator 105 in a fixed position while the rotor (not shown) may rotate relative to the stator 105. The housing 110 may surround the iron core 120 of the stator 105.

The housing 110 may define at least one opening 160 configured to receive at least a portion of the orifice plate 140. The opening 160 may mimic the general shape and size of the orifice plate 140 and aid in maintaining the orifice plate within the housing 110 during operation. The opening 160 may maintain the orifice plate 140 in a fixed position relative to the end windings 135.

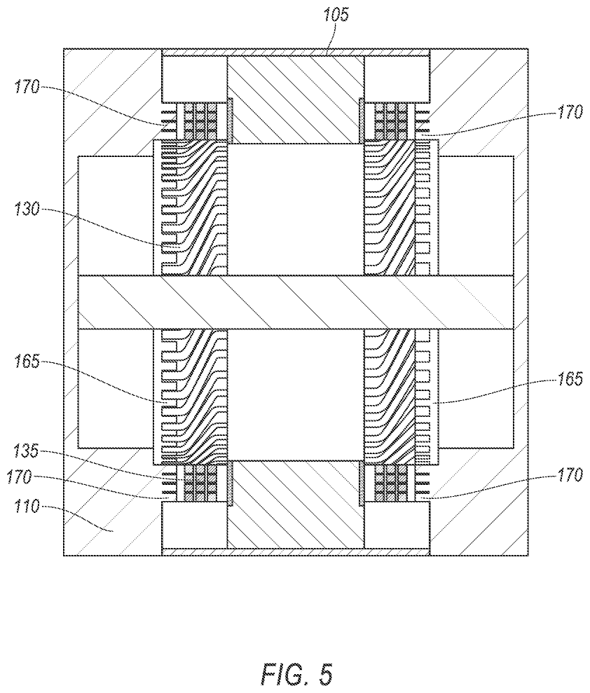

FIG. 5 illustrates a side view of another example cooling system 100. In this example, the housing 110 forms the orifice plates by creating an orifice opening 165 around the end windings. The orifice opening 165 may define a space that would otherwise have been defined by the orifice plate 140. The housing 110 may also define at least one nozzle 170 configured to provide coolant to the end windings 135.

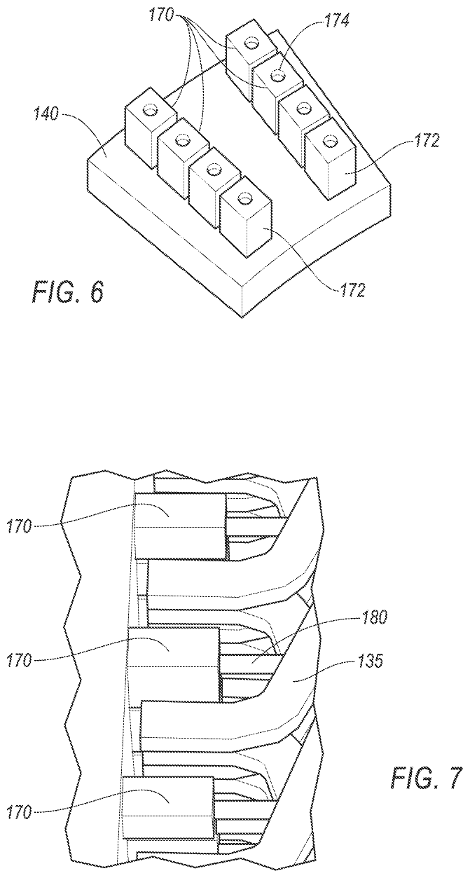

FIGS. 6-9 illustrate various examples of nozzle configurations. FIG. 6 illustrates a plurality of nozzles 170 arranged in two rows 172. Although two rows 172 are illustrated, more or less may be included on the orifice plate 140. Each nozzle 170 may define a nozzle opening 174 configured to allow coolant to flow therefrom. In the example in FIG. 6, the nozzles 170 may extend inward towards the end windings 135 and provide coolant therein, therebetween, and thereon to facilitate a more even coverage of coolant to the end windings 135.

FIG. 7 illustrates a side view of the nozzle configuration of FIG. 6 including the coolant flow 180. As explained, the nozzles 170 may extend inward and between the end windings 135. The coolant flow 180 may extend through the end windings 135, to more evenly coat the end windings.

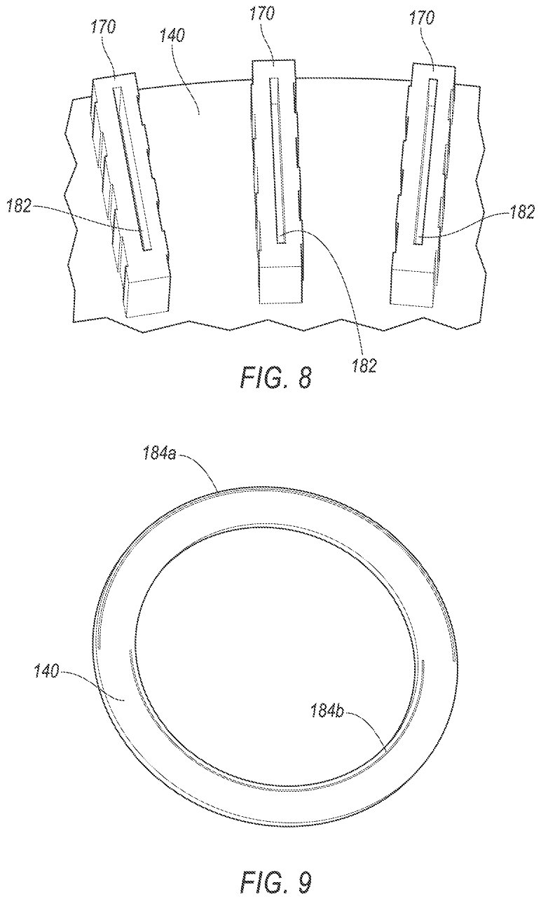

FIG. 8 illustrates a top view of the orifice plate 140 having another nozzle configuration. The nozzles 170 in this configuration include elongated nozzles extending across the radii of the orifice plate 140. The nozzles 170 include coolant slots 182, or elongated slots, configured to supply coolant therefrom. The nozzles 170, similar to the example in FIG. 6, may extend in between the end windings 135 to deliver coolant to, and in between the end windings 135.

The examples in FIGS. 6 and 8 allow for improved cooling performance in terms of lowering the maximum and average end winding temperatures. The nozzles 170 may be inserted between the copper welding points or copper turns to reduce the outlet-target gap size, as shown in FIG. 7. The coolant may be directly injected into each end winding through the nozzles 170, which can maximize the utilization of coolant and also greatly improve the end-winding temperature uniformity.

FIG. 9 illustrates a top view of an orifice plate 140 having a least one semi-circular nozzle 184a, 184b. The semi-circular nozzle 184a, 184b may extend along half of the orifice plate 140. In the example shown in FIG. 9, the orifice plate 140 includes two semi-circular nozzles, including an outer semi-circular nozzle 184a and a reciprocal inner semi-circular nozzle 184b. Coolant may be delivered out of these nozzles 184a, 184b. The outer nozzle 184a may cover the upper half of the end-windings at an outer diameter and the inner nozzle 184b may cover the inner half along a reciprocal inner diameter. As the rotor spins, the coolant may move along the end windings 135 right after being injected through the nozzles 184a, 184b. The slot (not labeled in FIG. 9) may form a continuous slot, or include multiple slots.

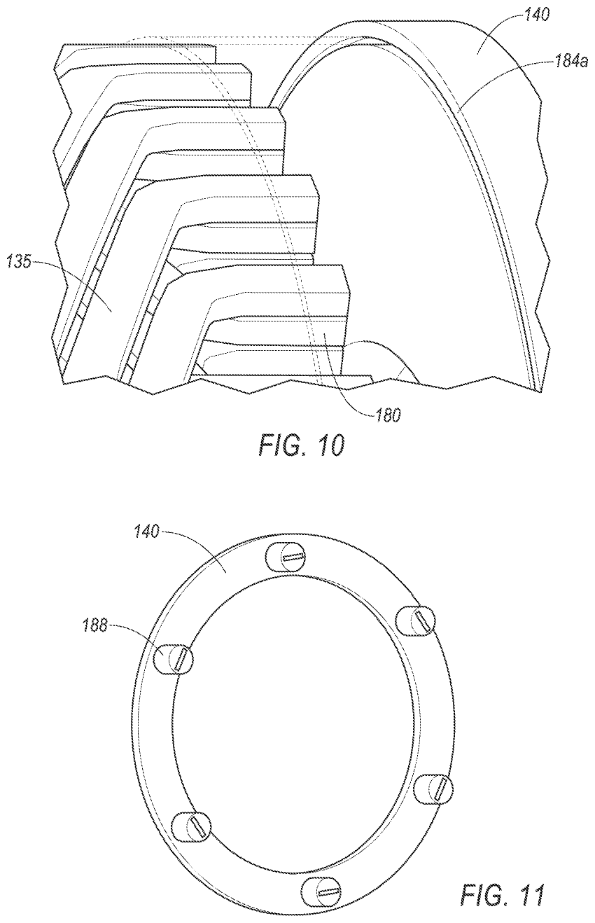

FIG. 10 illustrates a coolant flow 180 for the nozzle configuration of FIG. 9. For example, the coolant flow 180 may extend from the outer nozzle 184a and form a curtain of coolant around the outer diameter of the end windings 135. The centrifugal forces may allow the coolant to then uniformly coat the end windings 135. Gravity and air flow generated by the rotor spinning may allow the coolant to then uniformly coat the end windings 135.

FIG. 11 illustrates a top view of an orifice plate 140 having spray nozzles 188 arranged thereon. The spray nozzles 188 may be high pressure nozzles configured to spray the coolant.

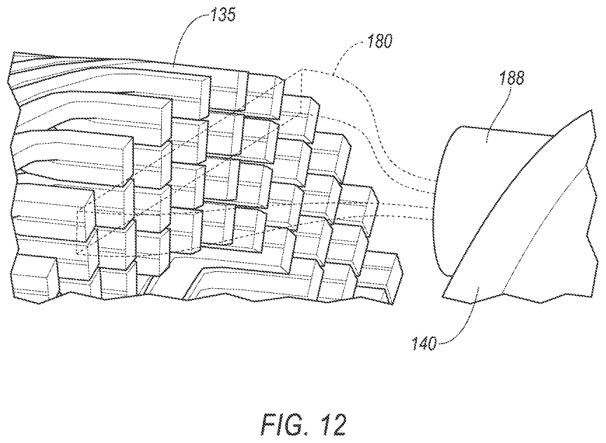

FIG. 12 illustrates a perspective view of the spray nozzles 188 of FIG. 11 illustrating a spray pattern 180 onto the end windings 135. In the example of FIG. 11, six spray nozzles 188 are arranged equidistantly around the orifice plate 140. The spray or coolant flow 180 may have a 60 degree angle interval to cover most of the end winding outer surfaces. This example capitalizes on a cooling with relatively small nozzle-to-target gap and low pressure drop. However, more or less nozzles 188 may be included and not necessarily at equidistant spacing.

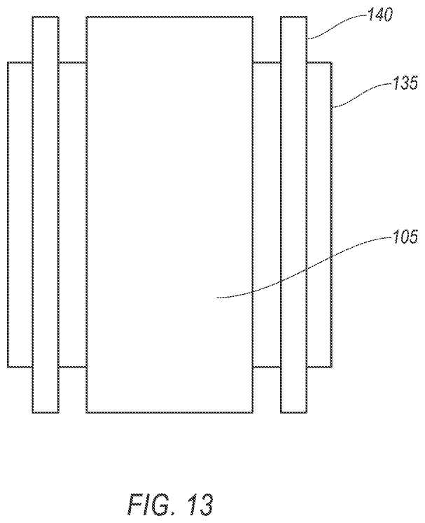

FIG. 13 illustrates a side view of another exemplary cooling system 200 where the orifice plate 140 forms a ring surrounding the end windings 153. The orifice plate 140 in this example, may include nozzles similar to those of FIG. 11 to deliver coolant to the sides of the end windings 135.

Thus, disclosed herein are coolant orifice plates enabling uniform coolant coverage at the end windings. This allows for higher cooling performance than traditional oil dripping, leading to significant reduction of the maximum and average operating temperatures. This improved coolant approach reduces the electric machine size requirements for a given torque output, increases electric machine torque densities, and increases efficiencies.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A cooling system for an electric vehicle motor, comprising:
a stator having a plurality of coils forming end windings at each of an end of the stator; and
at least one orifice plate arranged at the end windings of at least one end of the stator, the orifice plate including a plurality of nozzles configured to supply coolant at the end windings.

2. The cooling system of claim 1, wherein the orifice plate is a ring-like shape configured to cover the end windings.

3. The cooling system of claim 1, wherein each of the nozzles includes at least one slot configured to deliver the coolant.

4. The cooling system of claim 1, wherein the nozzles are arranged equidistantly and radially about the orifice plate and each extends across the diameter of the orifice plate and defines an elongated slot for delivering the coolant.

5. The cooling system of claim 1, wherein the nozzles are arranged one next to each other in at least one row along the orifice plate.

6. The cooling system of claim 1, wherein the nozzles are high pressure spray nozzles configured to spray coolant onto the end windings.

7. The cooling system of claim 1, wherein the nozzles include two reciprocal nozzles, one extending along half of an outer diameter of the orifice plate and the other extending along the other reciprocal half of an inner diameter of the orifice plate.

8. The cooling system of claim 7, wherein each of the nozzles include more than one opening configured to supply the coolant to the end windings.

9. A cooling system for an electric vehicle motor, comprising:
a stator having a plurality of coils forming end windings at each end of the stator;
at least one orifice plate arranged at the end windings of at least one end of the stator, the orifice plate configured to supply coolant at the end windings; and
a housing surrounding the stator and defining an opening at the end windings to maintain the at least one orifice plate therein.

10. The cooling system of claim 9, wherein the orifice plate includes a plurality of nozzles configured to supply the coolant to the end windings.

11. The cooling system of claim 10, wherein the nozzles extend outwardly from the orifice plate and between at least a portion of the end windings.

12. The cooling system of claim 9, wherein the orifice plate is a ring-like shape configured to cover the end windings.

13. The cooling system of claim 10, wherein each of the nozzles includes at least one slot configured to deliver the coolant.

14. The cooling system of claim 10, wherein the nozzles are arranged equidistantly and radially along the orifice plate and each extends across the diameter of the orifice plate and defines an elongated slot for delivering the coolant.

15. The cooling system of claim 10, wherein the nozzles are arranged one next to each other in at least one row along the orifice plate.

16. The cooling system of claim 10, wherein the nozzles are high pressure spray nozzles configured to spray coolant onto the end windings.

17. The cooling system of claim 10, wherein the nozzles include two reciprocal nozzles, one extending along half of an outer circumference of the orifice plate and the other extending along the other reciprocal half of an inner circumference of the orifice plate.

18. The cooling system of claim 17, wherein each of the nozzles include more than one opening configured to supply the coolant to the end windings.

19. A cooling system for an electric vehicle motor, comprising:
a housing configured to surround a stator having a plurality of coils forming end windings at each end of the stator, the housing configured to define at least one orifice plate arranged at the end windings of at least one end of the stator, the housing further defining a plurality of nozzles at the orifice plate to supply coolant between the end windings.

20. The cooling system of claim 19, wherein the orifice plate is defined by a ring-like shaped opening configured to provide a ring around the end windings.
